(19) United States
(12) Patent Application Publication
(10) Pub. No.: US 2009/0167178 A1
(43) Pub. Date: Jul. 2, 2009

(54) Illuminating Device Comprising Flat Discharge Lamp

(75) Inventor: Makoto Noda, Motosu-shi (JP)

Correspondence Address: SHERIDAN ROSS PC, 1560 BROADWAY, SUITE 1200, DENVER, CO, 80202, US

(73) Assignee: LECIP CORPORATION, Gifu-ken (JP)

(21) Appl. No.: 12/089,481

(22) PCT Filed: Oct. 11, 2005
(86) PCT No.: PCT/JP2005/018691

§ 371 Date: Jul. 22, 2008

(51) Int. Cl. H01J 61/04

(52) U.S. Cl. 313/621

(57) ABSTRACT

A flat discharge lamp (19) for an illumination device includes a transparent electrode (15) formed on a glass plate (12) located on an illumination surface side. A shield plate (34) is arranged between at attachment surface (31) and an electrode (14). The attachment surface has ground potential, and the transparent electrode and shield plate are electrically connected to a ground terminal (28E) of the drive circuit (28). The shield plate and transparent electrode, which have ground potential, electromagnetically shields the discharge lamp.

### FIELD OF THE INVENTION

The present invention relates to a lighting device, and more particularly, to a lighting device involving the application of high-frequency power or direct current pulses to a flat discharge lamp, including a dielectric plate having a flat illumination surface, for discharging and emitting light from the flat discharge lamp.

### BACKGROUND ART

FIG. 4 shows a conventional flat discharge lamp 19. Dielectric plates 11 and 12, such as glass plates, are arranged facing toward each other. The peripheries of the dielectric plates 11 and 12 are sealed by a seal glass 13. The dielectric plates 11 and 12 and the seal glass 13 form a flat hermetic case 16. Discharge gas is filled in the hermetic case 16. Electrodes 14 and 15 are respectively attached to the dielectric plates 11 and 12 so that the dielectric plates 11 and 12 and the discharge gas are placed therebetween. The dielectric plates 11 and 12 have opposing inner surfaces on which fluorescent material layers 17 and 18 are respectively formed. The discharge gas may be, for example, xenon (Xe) gas, or mercury vapor and argon (Ar) or neon (Ne) gas.

A drive circuit 28, which causes the flat discharge lamp 19 to emit light, is connected to a direct current power supply 23, which includes a rectifying-smoothing circuit 22 for rectifying and smoothing alternating current power supplied from, for example, a commercial power supply 21. The drive circuit 28 includes an inverter 24, which converts the direct current power of the direct current power supply 23 to high-frequency power, and a transformer 25, which boosts the high-frequency power. The drive circuit applies the boosted high-frequency power between the electrodes 14 and 15 to illuminate the discharge lamp 19. More specifically, the application of the high-frequency power causes discharging between the dielectric plates 11 and 12 (discharging performed by the dielectric plates 11 and 12 and thus referred to as dielectric barrier discharge). The dissociation of the discharge gas generates discharge plasma, and ultraviolet light from the discharge plasma excites the fluorescent material layers 17 and 18 to emit natural light to the exterior.

FIG. 5 shows an illumination device employing the flat discharge lamp 19. In addition to the flat discharge lamp 19, the illumination device includes a globe 27, which is made of a transparent resin and which accommodates the drive circuit 28 that includes the inverter 24 and transformer 25. Two power supply connectors 29H and 29E are attached to a side plate of the globe 27. The illumination device is installed in, for example, a ceiling 31. The direct current power supply 23 is connected to the power supply connectors 29H and 29E. When the illumination device is used in, for example, a wagon for interior illumination, the ceiling 31 is the roof of the vehicle body of the wagon, and the DC current supply is the battery mounted in the wagon.

### Patent Document 1: Japanese Laid-Open Patent Publication No. 2003-31182 (FIG. 2)

### DISCLOSURE OF THE INVENTION

In the conventional illumination device, when the globe 27 is detached for inspection or maintenance purposes, a person 32 may inadvertently touch the transparent electrode 15 on the illumination surface since he may not notice the electrode 15. The peak voltage applied between the electrodes 14 and 15 is a high voltage of, for example, 1 kV. Thus, safety precautions should be taken to prevent the person 32 from being subject to electric shock.

Further, the illumination device may be installed at a relatively low position. The drive power of an illumination device is high-frequency or direct current pulses of about 10 kHz to 100 kHz. Thus, when the person 32 stands up and approaches the illumination device, high-frequency current may leak through stray capacitance. C1 produced between the person 32 and the transparent electrode 15. This increases the input current of the drive circuit 28 and increases loss.

It is an object of the present invention that prevents electric shock when a person touches an illuminated transparent electrode and prevents high-frequency current leakage through stray capacitance between the person and the transparent electrode.

To achieve the above object, an illumination device according to the present invention includes a flat discharge lamp having a flat illumination surface and defining a discharge chamber in which discharge gas is filled. The flat discharge lamp includes a dielectric plate functioning as the illumination surface and two electrodes arranged to face towards each other so that the dielectric plate and the discharge chamber are located therebetween. A drive circuit drives the flat discharge lamp and includes a ground terminal having a ground potential. One of the two electrodes is a transparent electrode arranged on the illumination surface of the flat discharge lamp and electrically connected to the ground terminal.

### BRIEF DESCRIPTION OF THE DRAWINGS

FIG. 1 is a cross-sectional view of an illumination device according to a first embodiment of the present invention;

FIG. 2 is a cross-sectional view of an illumination device according to a second embodiment of the present invention;

FIG. 3 is a cross-sectional view of an illumination device according to a third embodiment of the present invention;

FIG. 4 is a cross-sectional view of a conventional flat discharge lamp; and

FIG. 5 is a schematic diagram showing an example of how the illumination device of FIG. 4 is used.

### BEST MODE FOR CARRYING OUT THE INVENTION

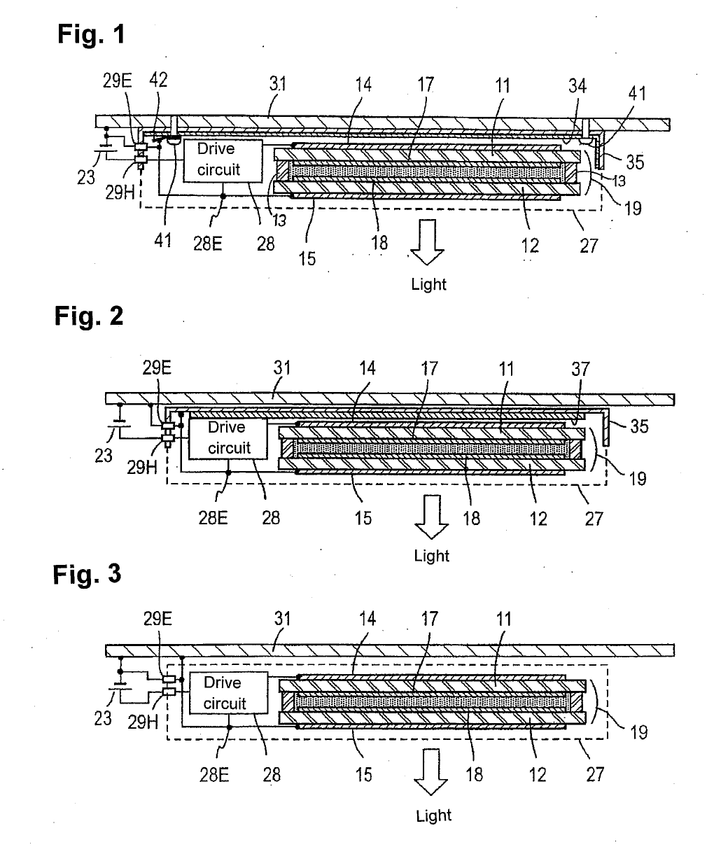

An illumination device according to a first embodiment of the present invention will now be described with reference to FIG. 1. In FIGS. 1 to 4, same or similar components are denoted by the same reference numerals and will be described only once.

The illumination device includes a flat discharge lamp 19, which has a flat illumination surface, and a drive circuit 28, which drives the flat discharge lamp 19. The flat discharge lamp 19 includes dielectric plates 11 and 12, a seal member 13 (e.g., seal glass), which seals the peripheries of the dielectric plates 11 and 12, and electrodes 14 and 15, which are respectively arranged on the dielectric plates 11 and 12. The dielectric plates 11 and 12 and the seal member 13 define a discharge chamber in which discharge gas is filled. The dielectric plate 12 functions as an illumination surface. The electrode 15 is a transparent electrode electrically connected to a ground terminal 28E of the drive circuit 28.

A shield plate 34 is arranged near a rear surface (surface at the side of the dielectric plate 11) of the flat discharge lamp 19 opposite to the illumination surface. A rear case 35 forms the rear surface and part of side surfaces of the globe 27. The rear case 35 is, for example, a molded product of synthetic resin. A metal film functioning as the shield plate 34 is formed on the inner surface of the rear case 35. The metal film can be formed by, for example, electrolytic plating and electroless plating. The rear case 35 may be formed by a metal plate or metal meshes. In this case, the rear case 35 itself functions as the shield plate 34. In the example of FIG. 1, the rear case 35 also functions as the shield plate 34. A shield plate 34 that is separate from the globe 27 may be arranged in the globe 27.

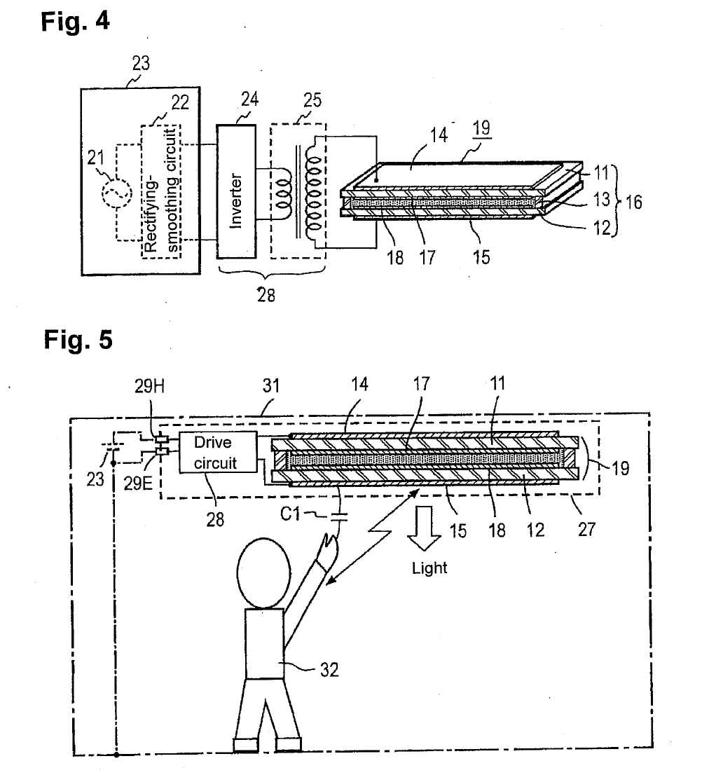

The shield plate 34 is electrically connected to a ground connector 29E. Power supply connectors 29H and 29E are attached to the rear case 35. The power supply connectors 29H and 29E are respectively connected to the cathode and anode of the direct current power supply 23. In the rear case 35, the power supply connector 29H is connected to a positive terminal of the drive circuit 28, and the power supply connector 29E is connected to a negative terminal, or the ground terminal 28E, of the drive circuit 28. In one example, the drive circuit 28 is laid out on a wiring board. A secondary wire of a transformer 25 (FIG. 4) that is connected to the transparent electrode 15 is connected to a common potential wire of the wiring board, that is, a wire connected to the power supply connector 29E. Tap screws 41 are fastened, for example, from the inner surface of the rear case 35, to an attachment surface 31 to secure the illumination device to the attachment surface 31. The attachment surface is, for example, a vehicle ceiling made of a conductive material such as metal. In this case, a lug terminal 42 is arranged between the head of each tap screw 41 and the shield plate 34 to electrically connect the lug terminal 42 to the ground terminal 28E of the drive circuit 28. This grounds the shield plate 34 in a satisfactory manner. In a vehicle, the negative electrode of the power supply 23 is normally connected to the vehicle body. Thus, the negative electrode of the power supply 23 is electrically connected to the ceiling 31.

The illumination device of the first embodiment has the advantages described below.

The transparent electrode 15 has ground potential, or the same potential as a person 32. Thus, even when inadvertently touching the transparent electrode 15, the person 32 would not be electrified. Thus, the illumination device of the first embodiment has a high level of safety.

The person 32 and the transparent electrode 15 both have ground potential. Thus, for example, even if the head of the person 32 comes close to the illumination device in an illuminated state, stray capacitance would not be formed between the head and the transparent electrode 15. Thus, in the illumination device of the first embodiment, leakage of high-frequency drive current is prevented, and power loss is reduced.

The shield plate 34 prevents the emission of disturbance electric waves from the discharge lamp 19. The flat discharge lamp 19 has a thickness of, for example, 2.5 mm, which is significantly less than the wavelength of the drive high-frequency. Further, the transparent electrode 15 has a relatively wide area of, for example, about 10×15 cm². Thus, even in a state in which the flat discharge lamp 19 is arranged between the grounded transparent electrode 15 and the grounded shield plate 34, the emission of disturbance electric waves is suppressed. Particularly, the shielding is sufficient when the shield plate 34 has side walls surrounding the side surfaces of the flat discharge lamp 19.

When the rear case 35 functions as the shield plate 34, there is no need to provide the shield plate 34 as a separate component. This reduces the number of components in the illumination device and enables the illumination device to be manufactured with low cost.

The transparent electrode 15 is used as a current shield. This enables the illumination device to be manufactured at a low cost in comparison to when entirely shielding the flat discharge lamp 19.

FIG. 2 shows an illumination device according to a second embodiment of the present invention. The drive circuit 28 includes a conductive heat radiation plate 37, which extends along the rear surface of the flat discharge lamp 19. The heat radiation plate 37 is arranged to be near substantially the entire rear surface of the flat discharge lamp 19. The heat radiation plate 37 is electrically connected to the ground terminal 28E of the drive circuit 28. For example, the heat radiation plate 37 is electrically connected to the power supply connector 29E. The transparent electrode 15 is electrically connected to the ground terminal 28E.

The illumination device of the second embodiment has the same advantages as the first embodiment.

FIG. 3 shows an illumination device according to a third embodiment of the present invention. The attachment surface 31 is, for example, a grounded conductor plate such as a metal ceiling of a wagon. The electrode 14, which is arranged on the rear surface of the flat discharge lamp 19 opposite the illumination surface, is located near the ceiling 31. The transparent electrode 15 is connected to the ground terminal 28E of the drive circuit 28. A shield plate 34 (refer to FIG. 34) is not arranged between the electrode 14 and the ceiling 31.

The flat discharge lamp 19 is electromagnetically shielded by the ceiling 31, which has ground potential, and the electrode 14, which is connected to the ground terminal 28E. Thus, the illumination device of the third embodiment obtains the same advantages as the first and second embodiments without using the shield plate 34.

In FIGS. 2 and 3, the connection of the ground terminal 28E of the drive circuit 28 and the ceiling 31 is not shown in detail. For example, as shown in FIG. 1, the rear case 35 or the globe 27 is secured to the ceiling 31 by a tap screw, with the ground terminal 28E connected thereto.

In any one of FIGS. 1 to 3, for repairing and inspecting purposes, the removal or opening of the globe 27 may be enabled. Alternatively, the removal or opening of a plate at the illumination surface side of the globe 27 may be enabled.

A heat insulation layer or soundproof layer may be applied to the inner surface of the metal ceiling 31 of a vehicle. The thickness of such layers differs in accordance with the vehicle type. Even in such cases, by employing the illumination devices of the first and second embodiments, a predetermined shielding effect can be obtained.

1. An illumination device comprising:
a flat discharge lamp having a flat illumination surface and defining a discharge chamber in which discharge gas is filled, with the flat discharge lamp including a dielectric plate functioning as the illumination surface and two electrodes arranged to face towards each other so that the dielectric plate and the discharge chamber are located therebetween; and
a drive circuit which drives the flat discharge lamp and includes a ground terminal having a ground potential;
wherein one of the two electrodes is a transparent electrode arranged on the illumination surface of the flat discharge lamp and electrically connected to the ground terminal.

2. The illumination device according to claim 1, wherein the flat discharge lamp includes a rear surface opposite to the illumination surface, the illumination device further comprising:
a shield plate electrically connected to the ground terminal and arranged facing toward the rear surface of the flat discharge lamp.

3. The illumination device according to claim 2, wherein the shield plate is part of a case surrounding the flat discharge lamp and the rear surface.

4. The illumination device according to claim 1, wherein:
the flat discharge lamp has a rear surface opposite the illumination surface;
the drive circuit is arranged next to an end of the rear surface of the flat discharge lamp;
the drive circuit includes a conductive heat radiation plate extending along the rear surface of the flat discharge lamp; and
the heat radiation plate is electrically connected to the ground terminal.

5. The illumination device according to claim 2, wherein the shield plate and the transparent electrode are maintained at a ground potential when the illumination device is illuminated.
